(19) United States
(12) Patent Application Publication
(10) Pub. No.: US 2026/0311020 A1
(43) Pub. Date: Oct. 8, 2026

(54) REAL-TIME TELEMETRY SHARING BETWEEN QUANTUM MANAGEMENT INSTANCES

(71) Applicant: Dell Products L.P., Round Rock, TX (US)

(72) Inventors: Brendan Burns Healy, Haddonfield, NJ (US); Paulo de Figueiredo Pires, Niterói (BR)

(21) Appl. No.: 19/169,881

(22) Filed: Apr. 3, 2025

(51) Int. Cl. G06N 10/40; G06N 20/00

(52) U.S. Cl. CPC G06N 10/40; G06N 20/00

(57) ABSTRACT

One example method is directed to quantum job orchestration, and includes obtaining, by an orchestration instance, telemetry from respective control planes associated with one or more QPUs (quantum processing units), providing the telemetry as input to an ML (machine learning) model of the orchestration instance, using the ML model to perform an inferencing process whose output is a profile that comprises information usable to make an orchestration decision for a job, based on the profile, orchestrating the job to a particular one of the QPUs, and broadcasting the profile to one or more other orchestration instances.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to quantum computing. More particularly, at least some embodiments relate to systems, hardware, software, computer-readable media, and methods, for real-time telemetry sharing between quantum management instances.

### BACKGROUND

A variety of companies host “virtual private clouds” for customers, enabling the customers to own dedicated hardware for their own usage, which is not shared with other entities. In typical cases, the hardware is hosted and maintained by the virtual private cloud provider, removing the burden of developing in-house data center management from the customer.

There is some interest in the field in implementing a deployment which would enable users to add (on-prem or cloud access) QPUs (quantum processing units) to such an arrangement. However, the QPUs would, most likely, not be owned entirely by individual customers, due to the excessive cost and unlikeliness of being able to achieve full uptime usage by an individual customer.

Thus, each hybrid quantum-classical system or orchestrator instance would need to run on an individual cluster, because the hybrid workflow would mean the classical portions would run, in a data-protected way, on individually-owned CPU/GPU nodes owned by the customer. This approach would require significant orchestration work – such as monitoring queueing, and inferencing ML models for resource prediction, for example – to be performed individually by each instance, thus resulting in significant duplication of effort as among the instances. This problem becomes worse as the number of instances grows, and may result in inefficient use of resources, and/or the consumption of resources needed elsewhere, among other things.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example datacenter architecture.

FIG. 1a discloses a modification of the example datacenter architecture, according to one embodiment.

FIG. 2 discloses aspects of a method, according to one embodiment.

FIG. 3 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to quantum computing. More particularly, at least some embodiments relate to systems, hardware, software, computer-readable media, and methods, for real-time telemetry sharing between quantum management instances. In an embodiment, telemetry may be gathered, and shared, in real-time as the telemetry is being generated.

One or more example embodiments comprise methods and architectures for implementing real time telemetry sharing between quantum management instances. One particular environment for an embodiment is one that involves virtual private clouds hosted by respective providers and made available to customers. The customers are able to own dedicated hardware for their own usage, which is not shared with other entities. This hardware may be hosted and maintained by the virtual private cloud provider. One deployment implemented in such an environment is one that enables users to add, whether on-prem or in a cloud access, one or more QPUs (quantum processing units) to such an arrangement. In some circumstances at least, the QPUs may not be owned entirely by individual customers, at least due to the excessive cost and unlikeliness of being able to achieve full uptime usage by an individual customer. Thus, an embodiment may enable, and implement, real-time telemetry sharing between quantum management instances in the environment. One example of such telemetry is queue time estimation for execution of a submitted quantum job by various QPUs.

One non-limiting example of a method according to an embodiment may comprise various operations that may be performed in connection with one or more QPUs that each have a respective classical computing control plane that includes a queue of jobs, and respective telemetry for each of the jobs. This method may comprise operations including, but not limited to: by each control plane of a group of control planes, maintaining a list of jobs submitted to a QPU with which that control plane is associated; storing respective telemetry for each of the jobs in the list of jobs; by an ML (machine learning) model of an instance of an orchestrator associated with one of the QPUs, obtaining the telemetry from each of the control planes; and, by the ML model, and based on the telemetry, determining which QPU a particular quantum job should be sent to. In an embodiment, the telemetry information may be broadcast by the instance of the orchestrator to other respective instances of orchestrators, each associated with a respective QPU.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may provide for efficient use of telemetry in making quantum job orchestration decisions. An embodiment may make use of work results from a variety of entities in making quantum job orchestration decisions. An embodiment may provide up to date information for use in orchestration of a quantum job. An embodiment may provide real-time queue time estimation sharing between quantum middleware instances, reducing computational burden. Various other advantages of one or more example embodiments will be apparent from this disclosure.

### A. Aspects of an Example Architecture for one Embodiment

The following is a discussion of aspects of example architectures for various embodiments. This discussion is not intended to limit the scope of the claims or this disclosure, or the applicability of the embodiments, in any way.

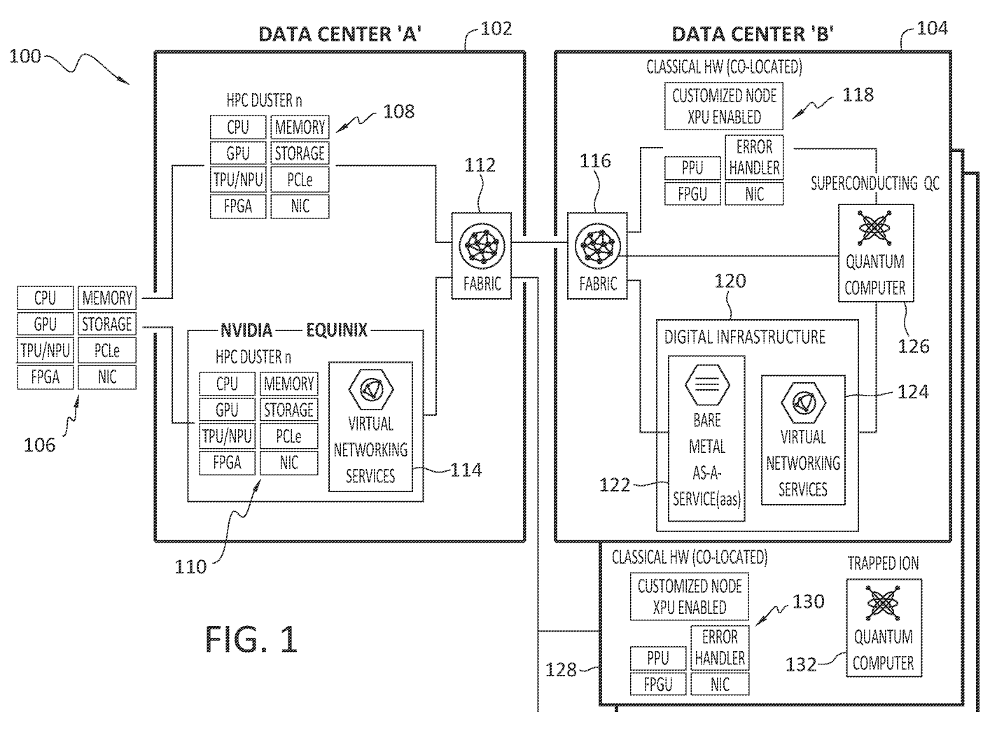

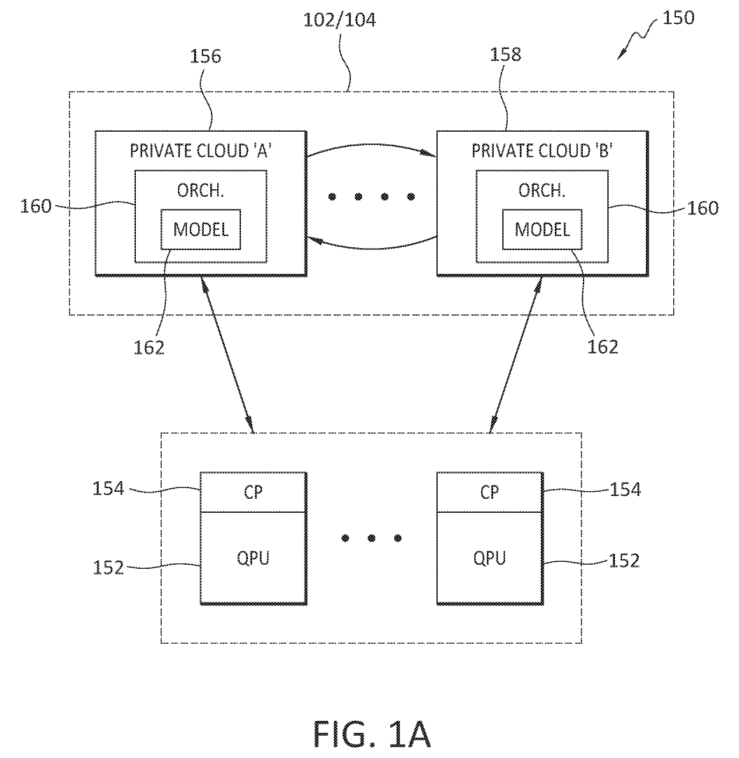

In particular, and with reference to the example of FIG. 1, an architecture 100 according to one embodiment is disclosed. By way of brief overview, the example of FIG. 1 involves an orchestrator, such as the Dell QIO (Quantum Intelligent Orchestrator) which may comprise a classical computing middleware layer that handles orchestration tasks and provides additional functionality powered by classical computing processors. In an embodiment, a QIO instance refers to a particular running process implementing this application, that is, the handling of the orchestration tasks. The orchestrator may be implemented in a centralized mode, in which a single orchestrator operates in conjunction with multiple customers, or a decentralized mode in which each customer controls its own respective orchestrator. That is, an embodiment may be agnostic with respect to a particular implementation mode.

As shown in FIG. 1, and indicated above, the architecture 100 may comprise a datacenter ‘A’ 102 and a datacenter ‘B’ 104 that may communicate with each other. The datacenters 102 and 104 may be hosted in different respective locations, such as on-premises, and in a cloud environment, for example. One example of the datacenter 102 is an Equinix DC2, and an example of the datacenter 104 is an Equinix DC1. One or both of the datacenters 102 and 104 may comprise a respective virtual private cloud that may comprise, or to which may be added, one or more QPUs (quantum processing units).

The datacenter 102 may communicate with a computing cluster 106 which may, in one embodiment, comprise a Dell HPC (high performance computing) cluster. See, e.g., https://thequantuminsider.com/2022/11/15/dell-technologies-advances-high-performance-computing-with-hybrid-quantum-classical-system/ (incorporated herein). As well, the datacenter 102 itself may comprise one or more computing clusters 108 and 110 which may be implemented together, and communicate, with a fabric 112, such as an Equinix fabric for example, that provides flexible and virtual interconnection among digital infrastructures and services. See https://www.equinix.com/products/digital-infrastructure-services/equinix-fabric (incorporated herein). The example datacenter 102 may further comprise virtual networking services 114 which, in one example embodiment, may comprise the Equinix Network Edge platform. See, e.g., https://www.equinix.com/products/digital-infrastructure-services/network-edge (incorporated herein.

Turning next to the datacenter 104, included components, all of which may communicate with each other, may comprise a fabric 116, which may or may not be the same as the fabric 112. As shown, the fabrics 116 and 112 may communicate with each other. The datacenter 104 may also comprise a computing cluster 118 which may or may not be the same as the computing cluster 108, or computing cluster 110. A digital infrastructure 120 of the datacenter 104 may comprise a bare metal as-a-Service (aaS) module 122 and virtual networking services 124. In one embodiment, the bare metal as a-Service (aaS) module 122 may comprise Equinix Metal. See, e.g., https://www.equinix.com/resources/data-sheets/equinix-metal (incorporated herein). In an embodiment, the virtual networking services 124 may comprise the Equinix Network Edge platform, noted above. The digital infrastructure 120 may communicate with a quantum computer (QC) 126, such as a superconducting quantum computer for example.

Another example datacenter 128 may comprise various components. For example, the datacenter 128 may comprise a computing cluster 130, and a quantum computer 132, such as a trapped ion quantum computer for example.

With attention now to FIG. 1a, an example is disclosed of a modification that may be implemented in a datacenter, or other multi-tenant environment. By way of overview, these tenants may comprise one or more private clouds, or other entities, may each have its own instance of an orchestration module, such as the Dell QIO for example, for performing various orchestration tasks that may involve the use of one or more QPUs to carry out a job that has been orchestrated to the QPU by the orchestration module.

It is noted that because QPUs are expensive to buy/maintain, they typically are not allocated to any particular user or tenant, but may be available to all users. Thus, when a particular instance of an orchestration module needs to employ QPU resources, the orchestration module can obtain telemetry from the respective control planes of each of the QPUs. Additionally or alternatively, that orchestration module instance may receive a broadcast from a parallel orchestration module instance, or, in some embodiments, the telemetry may be broadcast to the control planes, in which case it may be picked up from there.

Using the telemetry, the orchestration module instance can determine, as one non-limiting example of telemetry type and usage, which QPU has the shortest potential queue time. That orchestration module instance can then send, or orchestrate, the quantum portion of its job to that QPU with the shortest queue time. In an embodiment, this orchestration may assume that the orchestration module has performed the rest of its value add, because some of the value add may be dependent on the chosen QPU, so there may be an intervening step between identifying a quantum resource and shipping the job to the QPU. This is especially true if there are QPUs present of different modalities and/or topologies.

In addition to its orchestration functions, the orchestration module instance may also notify, such as by way of a broadcast, the other orchestration modules instances – associated with different respective tenants – which of the QPUs has the shortest queue time. Additionally, or alternatively, the shortest queue time information may be obtained by the other tenants directly from the respective control planes of the QPUs. Finally, it is noted that the information shared in the broadcast to the other orchestration modules instances does not include customer specific information – only information about the QPU telemetry.

Turning now to the example of FIG. 1a, details are provided concerning one particular implementation according to an embodiment. In particular, an architecture 150 may comprise one or more QPUs 152, each of which may be associated with a respective control plane (CP) 154. The QPUs152 may be accessible by, but not specifically associated with, or under the control of, any particular customer, tenant, or entity. For example, the datacenter 102 may comprise various entities including, but not limited to, one or more private clouds 156 and 158 and/or other tenants that may have a need for QPU 152 resources. In this example, each of the private clouds 156 and 158 may be able to independently access the QPUs 152 as needed to perform quantum computing jobs which may or may not be elements of a hybrid job that includes both classical and quantum components.

The private clouds 156 and 158, and/or other computing entities of the datacenter 102, may each comprise a respective instance of an orchestration module 160 that may operate to orchestrate jobs of the host private cloud to the QPU(s) 152. The orchestration modules 160 may each host a respective model 162, which may comprise an ML model, that is operable to receive, as input from one or more of the CPs 154 for example, respective telemetry relating to one or more of the QPUs 152, and using that input to make an orchestration decision for jobs received by the instance of the orchestration module 160.

As shown in FIG. 1a, each of the private clouds 156 and 158, or other tenants, is able to communicate with the others. In this way, each of the orchestration module instances 160 may be able to obtain telemetry from the other orchestration module instances 160, concerning jobs orchestrated to, and performed by, the CPUs by those other orchestration module instances 160. This information may be used by the other orchestration module instances 160 to make orchestration decisions.

### B. Detailed discussion of Aspects of an Embodiment

### B.1 Introduction

It is noted that in the following discussion, reference is made to various specific systems and components that may be employed in one or more embodiments. These are provided only for the purposes of illustration, and are not intended to limit the scope of this disclosure, or of any claims, in any way.

In particular, reference is made below to a DQCS (Dell Quantum Computing Solution). See, for example, https://thequantuminsider.com/2022/11/15/dell-technologies-advances-high-performance-computing-with-hybrid-quantum-classical-system/. The DQCS refers to a specific server configuration that may be employed, in one embodiment, to provide a platform for launching hybrid quantum-classical jobs. The DQCS is one particular implementation of a classical computing node existing between a quantum accelerator and an end-user.

Reference is also made below to the Dell QIO (Quantum Intelligent Orchestrator). A QIO is one particular implementation of a classical computing middleware layer handling orchestration tasks.

### B.2 Discussion

One embodiment comprises propose a method by which work results are shared between multiple instances of an orchestrator. Among other things, such an approach may be expected to reduce overhead for customers, and ease unnecessary burdens on their owned hardware.

As noted herein, embodiments may implement orchestration decisions based on telemetry generated by QPUs in performing a job, or jobs. In general, such telemetry may comprise any information concerning the job itself, performance of the job, and resources used to perform the job. The following discussion considers, only for illustrative purposes and not by way of limitation, the example of queue time estimation.

In this example, each QPU will have its own classical computing control plane, or simply ‘control plane,’ such as a rack server for example, not living within the fence of any particular customer(s). On the control plane will live a queue of jobs and their telemetry, for example, qubit number, circuit width, and number of shots.

Each orchestrator instance, which may comprise a QIO in one embodiment, may include an ML model, and the ML models may be the same across all the orchestrator instances, unless a customer wishes to fine-tune a particular ML model. The orchestrator instance can take in this telemetry from each control plane and make its own determination about potential queue times and thus make an informed decision about where to send its jobs, that is, quantum computing jobs sent to the orchestrator by one or more users, for example. In an embodiment, an orchestrator instance may host additional AI (artificial intelligence) models performing various other functions.

It is noted that, in one embodiment, this inferencing does not take place at the QPU control plane, for multiple reasons. For example, that particular control plane is not guaranteed to host sufficient compute to support these ML models, and that particular control plane may be biased towards its hosted QPU, that is, favoring the hardware of that particular vendor, and so cannot be a-priori trusted not to artificially deflate queue time estimation so that the job is sent to the QPU associated with that control plane.

Thus if customer A private cloud needs to submit a job, it will inference the ML models corresponding to the available QPUs, which may be on-prem or in an accessible cloud environment, and derive a profile of likely wait times. That is, the private cloud may request a respective inferencing process be performed by each of the ML models. Then the orchestrator instance associated with that customer will broadcast this information to the other orchestrator instances. It is noted that this information that is broadcast does not contain any sensitive customer information, such as anything about the submitted quantum job. As long as this data is fresh, this will obviate the need for additional pings and ML inferencing by other orchestrator instances. In this example, freshness may be determined with reference to a defined threshold, such as by an admin or user, and may subject to fine-tuning by the data center admin. Such a threshold may specify that any data newer than a particular timestamp, or clock time, is deemed to be suitably fresh.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

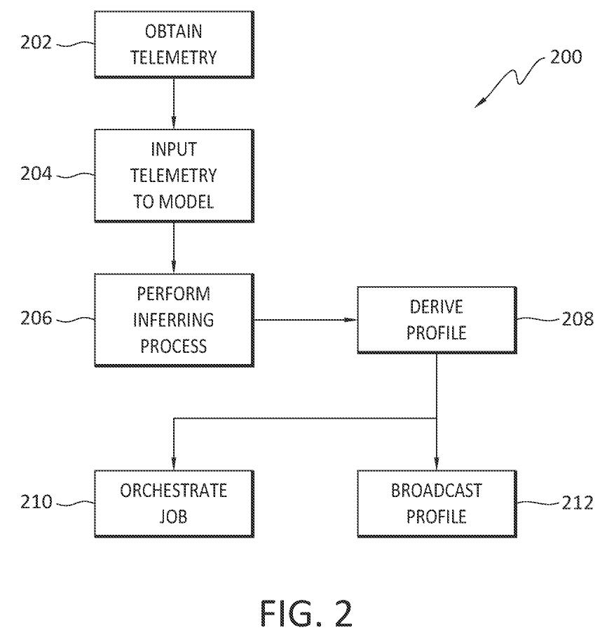

Directing attention now to FIG. 2, a method 200 according to one example embodiment is disclosed. In one embodiment, the method 200 may be performed in whole, or in part, by an orchestrator instance. The method 200 may be performed in connection with one or more QPUs that each are associated with a respective classical computing control plane that includes a queue of jobs, and respective telemetry for each of the jobs.

The method 200 may begin when an orchestration instance obtains 202 telemetry from respective control planes associated with one or more QPUs. This telemetry may then be provided 204 as input to an ML model of the orchestration instance. The ML model may then perform 206 an inferencing process using that input. As a result of the inferencing process 206, a profile may be generated 208 that may comprise information usable to make an orchestration decision for a job. The job may then be orchestrated 210 to a particular QPU based on the profile. At the same time as the orchestration 210, or before, or after, the profile may be broadcast 212 to one or more other orchestration instances.

### D. Further Example Embodiments

Following are some further example embodiments. These are presented only by way of example and are not intended to limit the scope of this disclosure or the claims in any way.

Embodiment 1. A method for quantum job orchestration, comprising: obtaining, by an orchestration instance, telemetry from respective control planes associated with one or more QPUs (quantum processing units); providing the telemetry as input to an ML (machine learning) model of the orchestration instance; using the ML model to perform an inferencing process whose output is a profile that comprises information usable to make an orchestration decision for a job; based on the profile, orchestrating the job to a particular one of the QPUs; and broadcasting the profile to one or more other orchestration instances.

Embodiment 2. The method as recited in any preceding embodiment, wherein information obtained as a result of running the job at the particular one of the QPUs is stored at a control plane associated with that particular QPU.

Embodiment 3. The method as recited in any preceding embodiment, wherein the telemetry comprises information concerning one or more jobs performed by the QPUs.

Embodiment 4. The method as recited in any preceding embodiment, wherein the orchestration instance broadcasts the profile.

Embodiment 5. The method as recited in any preceding embodiment, wherein each of the QPUs is customer specific.

Embodiment 6. The method as recited in any preceding embodiment, wherein the profile omits any sensitive customer information.

Embodiment 7. The method as recited in any preceding embodiment, wherein each of the control planes includes a queue of jobs which is associated with the telemetry.

Embodiment 8. The method as recited in any preceding embodiment, wherein the profile omits information about any particular job.

Embodiment 9. The method as recited in any preceding embodiment, wherein the control planes each comprise respective classical computing hardware and/or software.

Embodiment 10. The method as recited in any preceding embodiment, wherein the QPUs reside in a datacenter.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

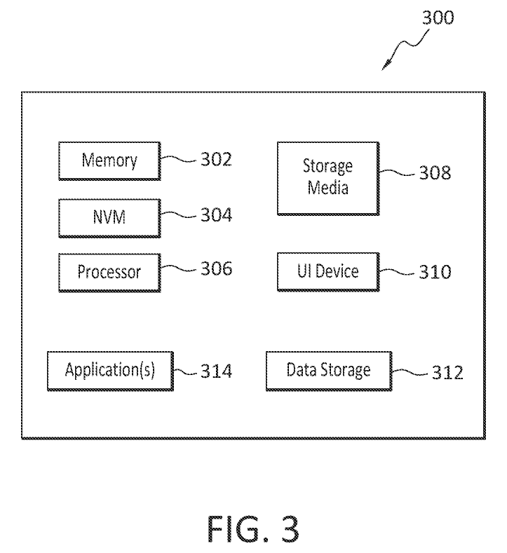

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for quantum job orchestration, comprising:
obtaining, by an orchestration instance, telemetry from respective control planes associated with one or more QPUs (quantum processing units);
providing the telemetry as input to an ML (machine learning) model of the orchestration instance;
using the ML model to perform an inferencing process whose output is a profile that comprises information usable to make an orchestration decision for a job;
based on the profile, orchestrating the job to a particular one of the QPUs; and
broadcasting the profile to one or more other orchestration instances.

2. The method as recited in claim 1, wherein information obtained as a result of running the job at the particular one of the QPUs is stored at a control plane associated with that particular QPU.

3. The method as recited in claim 1, wherein the telemetry comprises information concerning one or more jobs performed by the QPUs.

4. The method as recited in claim 1, wherein the orchestration instance broadcasts the profile.

5. The method as recited in claim 1, wherein each of the QPUs is customer specific.

6. The method as recited in claim 1, wherein the profile omits any sensitive customer information.

7. The method as recited in claim 1, wherein each of the control planes includes a queue of jobs which is associated with the telemetry.

8. The method as recited in claim 1, wherein the profile omits information about any particular job.

9. The method as recited in claim 1, wherein the control planes each comprise respective classical computing hardware and/or software.

10. The method as recited in claim 1, wherein the QPUs reside in a datacenter.

11. A non-transitory storage medium having stored therein instructions that are executable by one or more hardware processors to perform operations comprising:
obtaining, by an orchestration instance, telemetry from respective control planes associated with one or more QPUs (quantum processing units);
providing the telemetry as input to an ML (machine learning) model of the orchestration instance;
using the ML model to perform an inferencing process whose output is a profile that comprises information usable to make an orchestration decision for a job;
based on the profile, orchestrating the job to a particular one of the QPUs; and
broadcasting the profile to one or more other orchestration instances.

12. The non-transitory storage medium as recited in claim 11, wherein information obtained as a result of running the job at the particular one of the QPUs is stored at a control plane associated with that particular QPU.

13. The non-transitory storage medium as recited in claim 11, wherein the telemetry comprises information concerning one or more jobs performed by the QPUs.

14. The non-transitory storage medium as recited in claim 11, wherein the orchestration instance broadcasts the profile.

15. The non-transitory storage medium as recited in claim 11, wherein each of the QPUs is customer specific.

16. The non-transitory storage medium as recited in claim 11, wherein the profile omits any sensitive customer information.

17. The non-transitory storage medium as recited in claim 11, wherein each of the control planes includes a queue of jobs which is associated with the telemetry.

18. The non-transitory storage medium as recited in claim 11, wherein the profile omits information about any particular job.

19. The non-transitory storage medium as recited in claim 11, wherein the control planes each comprise respective classical computing hardware and/or software.

20. The non-transitory storage medium as recited in claim 11, wherein the QPUs reside in a datacenter.
